(19) United States
(12) Patent Application Publication
(10) Pub. No.: US 2005/0229496 A1
(43) Pub. Date: Oct. 20, 2005

(54) Door sash structure

(75) Inventors: Yujiro Tashima, Utsunomiya-shi (JP); Jiro Yamaguchi, Kawachi-gun (JP); Shun Kadota, Tokyo (JP); Hiroyuki Takagai, Kawachi-gun (JP); Futoshi Kobayashi, Utsunomiya-shi (JP); Takeshi Ishikawa, Ashikaga-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/098,314

(22) Filed: Apr. 4, 2005

(30) Foreign Application Priority Data
Apr. 6, 2004 (JP) 2004-112193

(51) Int. Cl. E06B 7/16

(52) U.S. Cl. 49/441

(57) ABSTRACT

A structure of a door sash of a vehicle, having a portion for holding a door glass. A glass seal is provided at an end portion of the door glass; outer faces of the door sash, the door glass, and the glass seal are substantially flush; a fitting convex portion, provided in the door sash more inwardly in comparison with the outer face of the door sash, is fit to a fitting concave portion provided in the glass seal more inwardly in comparison with the outer face of the glass seal. Typically, the fitting convex portion and the fitting concave portion are formed more inwardly in comparison with a contact portion between the door glass and the glass seal. Preferably, the door sash has an internally molded sectional form.

### BACKGROUND OF THE INVENTION

1. Field of the Invention

The present invention relates to a door sash structure for vehicles such as cars.

Priority is claimed on Japanese Patent Application No. 2004-112193, filed Apr. 6, 2004, the content of which is incorporated herein by reference.

2. Description of Related Art

In known vehicles such as cars, a partition sash may be provided, which is a door sash, and is vertically arranged in a rear portion of the opening of the rear door. In order to improve quality for appearance, the partition sash may have glass fitting portions at either side, so as to reduce the apparent width of the sash when observed from the outside of the vehicle (see Japanese Unexamined Patent Application, First Publication No. 2003-118371). Recently, further reduction of the apparent width of the partition sash is required in accordance with a progress in making structures in the vehicle body flush, so as to improve importance of design of the vehicle. However, the above partition sash, having a reduced apparent width, slightly protrudes from a glass surface; thus, a step is produced between the glass surface and the partition sash, thereby inhibiting a flush surface structure. Additionally, in order to further reduce the apparent width, the fitting (concave) portions of the partition sash, which hold glass seals, should be shallow. Therefore, it is difficult to secure necessary strength for holding the glass seals.

### SUMMARY OF THE INVENTION

In consideration of the above circumstances, an object of the present invention is to provide a door sash structure for providing a flush surface structure between the door sash and the glass surface, reducing the apparent width of the door sash, and reliably holding the glass seals.

Therefore, the present invention provides a structure of a door sash (e.g., a partition sash 21 in an embodiment explained below) of a vehicle, having a portion for holding a door glass (e.g., a partition glass 22 in the embodiment), wherein:
a glass seal (e.g., a glass seal 24 in the embodiment) is provided at an end portion (e.g., a front edge 23 in the embodiment) of the door glass;
outer faces of the door sash, the door glass, and the glass seal are substantially flush (refer to outer faces 46, 28, and 29 in the embodiment);
a fitting convex portion (e.g., a flange portion 32 in the embodiment), provided in the door sash at a more inner side of the vehicle in comparison with the outer face of the door sash (refer to the outer face 46 in the embodiment), is fit to a fitting concave portion (e.g., a concave portion 31 in the embodiment) provided in the glass seal at a more inner side of the vehicle in comparison with the outer face of the glass seal.

Accordingly, the structure (of the door sash) for holding the door glass is arranged at a more inner side of the vehicle in comparison with the door glass, thereby realizing a flush outer surface structure of the door sash. In addition, the apparent width of the door sash can be small, thereby improving salability.

Typically, the fitting convex portion and the fitting concave portion are formed at a more inner side of the vehicle in comparison with a contact portion (e.g., a slot 25 in the embodiment) between the door glass and the glass seal. In this case, the depth of the fitting portion in the door sash can be increased. Therefore, a sufficient strength for holding the door glass can be secured, and it is possible to reliably fit the door glass via the glass seal and to improve reliability in mounting of the door glass. Preferably, the door sash has a sectional form which is formable by integral molding and thus can be formed by roll molding, extrusion molding, or the like. Therefore, the surface condition of the door sash can be stable, thereby keeping a preferable state of the glass seal fit to the fitting portion. Accordingly, it is possible to reduce a burden on the glass seal.

Also preferably, a metal fitting (e.g., a metal fitting 33 in the embodiment) is embedded in a portion around the fitting concave portion. Accordingly, rigidity of the fitting concave portion of the glass seal can be improved, thereby improving rigidity in fitting between the fitting concave portion and the fitting convex portion and improving reliability in fitting in the glass seal.

In the door sash, the fitting convex portion may be a folded portion turning back to an opposite side. Such a folded portion increases the thickness of the fitting convex portion, and the (pointed) head of the fitting convex portion can be formed round. Therefore, it is easy to mount the glass seal to the fitting convex portion while increasing the rigidity of the fitting convex portion.

### BRIEF DESCRIPTION OF THE DRAWINGS

FIG. 1 is a perspective view of a vehicle in an embodiment according to the present invention.

FIG. 2 is a cross-sectional view along line A-A in FIG. 1.

### DETAILED DESCRIPTION OF THE INVENTION

Hereinafter, embodiments according to the present invention will be explained with reference to the drawings.

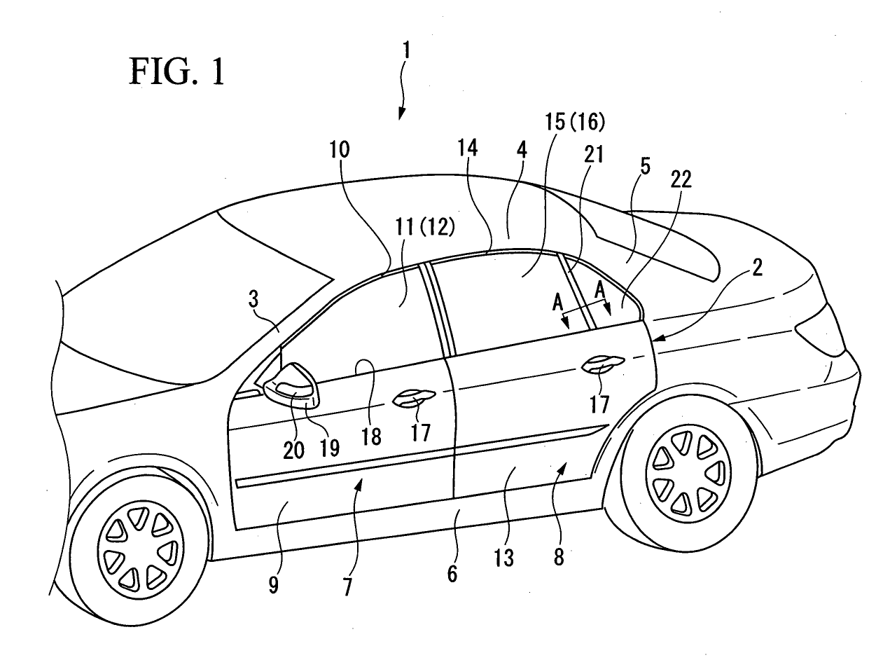

As shown in FIG. 1, at a side of a vehicle 1 (e.g., a car), an opening 2 for mounting doors is provided. This opening 2 is surrounded by a front pillar 3, a roof side rail 4, a rear pillar 5, and a side sill 6. A front door 7 and a rear door 8 are attached to the opening 2 in a manner such that each door can be freely opened and closed.

The front door 7 is composed of a door main body 9 and a sash 10. In a sash opening 11, a front door glass 12 is provided, which can be freely raised and lowered. The rear door 8 is also composed of a door main body 13 and a sash 14. In a sash opening 15, a rear door glass 16 is provided, which can also be freely raised and lowered. To the front door 7 and the rear door 8, outside handles 17 and 17 are respectively provided.

A door mirror 19 is attached at a corner between the front pillar 3 and the upper edge 18 of the main body 9 of the front door 7. A turn signal lamp 20 is provided in the door mirror 19.

At a rear side of the sash 14 of the rear door 8, a partition sash 21 (i.e., a door sash) is provided in the vertical direction. The sash opening 15 surrounded by the sash 14 of the rear door 8 is divided by the partition sash 12 into a front side and a rear side, where a rear door glass 16 is provided at the front side in a manner such that the door glass can be freely raised or lowered, and a partition glass 22 (i.e., a door glass) having a substantially triangular shape is fixed into a corner portion formed between the sash 14 and the door main body 13. Accordingly, the front side (or edge) of the partition sash 21 has a structure for guiding the rear door glass 16 which is raised or lowered. Here, the upper end of the partition sash 21 is joined to the sash 14, and the lower end of the partition sash 21 extends into the door main body 13 so that a portion of the partition sash 21 is contained in the door main body 13, where the contained portion can also guide the rear door glass 16.

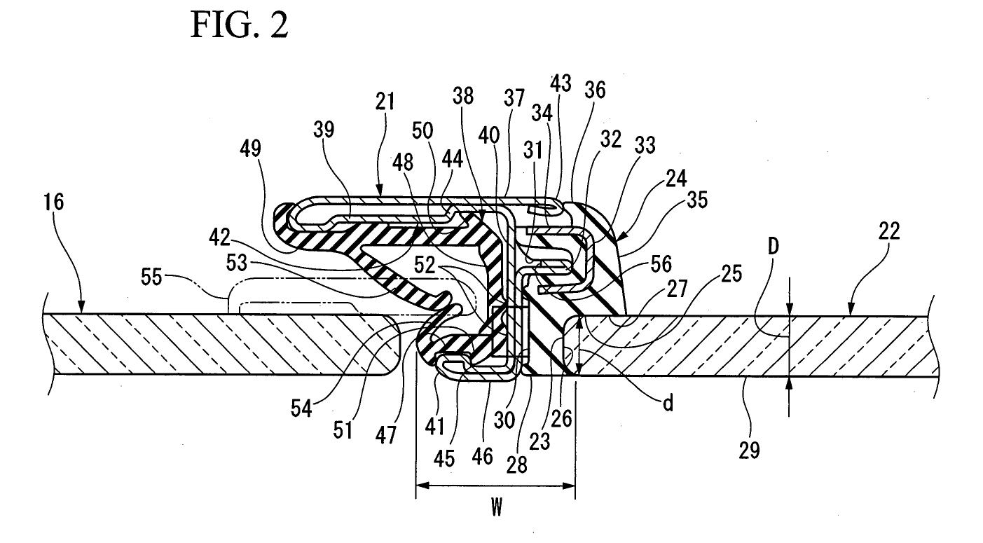

As shown in FIG. 2, a glass seal 24 made of rubber is adhered to the front edge 23 (i.e., the end portion) of the partition glass 22. In the glass seal 24, a slot 25 (as a joint portion) is provided, which has a substantially right-angle section, corresponding to the front edge 23 of the partition glass 22. This slot 25 is formed by a contact wall 26 which faces the front side of the vehicle, and an inner wall 27 at the interior side of the vehicle, where both walls are substantially perpendicular to each other.

The contact wall 26 provided in a front portion of the glass seal 24 has a width d (corresponding to a depth from the outside of the vehicle) which is substantially equal to the thickness D of the partition glass 22, by which the outer face 28 (at the outside of the vehicle) of the glass seal 24 and the outer face 29 of the partition glass 22 are made flush. On the other hand, the inner wall 27 of the glass seal 24, which faces the interior of the vehicle, has a slightly deeper width than the contact face 26, thereby securing a sufficient contact (i.e., adhesion) area between the partition glass 22 and the glass seal 24.

In the front wall 30 of the glass seal 24, a concave portion 31 (i.e., a fitting concave portion) is formed, where the concave portion 31 is positioned more inside (i.e., closer to the interior or the inner side of the vehicle) in comparison with the partition glass 22. To the concave portion 31, a flange portion 32 (i.e., a fitting convex portion) of the partition sash 21 is fit. A metal (core) fitting 33 having a U-shaped section is provided (i.e., embedded) in a portion around (the inner face of) the concave portion 31 of the glass seal 24. This metal fitting 33 is elastic and forces the inner wall of the concave portion 31 into the inside of the concave portion.

A lip portion 36 is formed between the inner wall 34 and the back wall 35 of the glass seal 24, and the pointed end of the lip portion 36 faces the front side of the vehicle and contacts the rear end 43 of the partition sash 21 (explained below). That is, the back wall 35 of the glass seal 24 is joined to the inner face 37 (which faces the interior of the vehicle) of the partition sash 37.

In a front portion of the partition sash 21, a glass run channel 42 for containing a glass run 38 (i.e., a window glass seal) is formed by an inner wall 39, a bottom wall 40, and an outer wall 41. In a rear portion of the partition sash 21, a flange portion 32 is provided, which rises toward the back side so as to fasten the glass seal 24.

The partition sash 21 has a cross-sectional form which can be realized by integral molding, and the inner wall 39, the bottom wall 40, the outer wall 41 of the glass run channel 42 and the flange portion 32 are formed by integral molding.

More specifically, the partition sash 21 is composed by (i) the inner wall 39 starting from a back side end 43 which closely contacts the lip portion 36 (of the glass seal 24) formed at the interior side of the vehicle, extending to the front side, and then turning back toward the back side, (ii) the bottom wall 40 extending from the inner wall 39 toward the outside of the vehicle, (iii) the outer wall 41 rising from an end of the bottom wall 40 to the front side, and then turning back toward the back side, and (iv) the flange portion 32 extending from the outer wall 41 to a center position of the bottom wall 40, then rising toward the back side, and then turning back to the front side. Therefore, the glass run channel 42 is formed by the inner wall 39, the bottom wall 40, and the outer wall 41.

In the vicinity of a base portion of the inner wall 39 of the glass run channel 42, a fitting portion 44 is provided, to which the glass run 38 is fit, and another fitting portion 45, to which the glass run 38 is also fit, is provided in the inner face of the outer wall 41. The flange portion 32 is fit to the above-explained concave portion 31 of the glass seal 24. Here, the outer face 46 of the outer wall 41, the outer face 28 of the glass seal 24, and the outer face 29 of the partition glass 22 are substantially flush.

The glass run 38 is mounted in the above-explained glass run channel 42 which is formed by the inner wall 39, the bottom wall 40, and the outer wall 41. The glass run 38 includes an outer wall 47, a bottom wall 48, and an inner wall 49, which respectively correspond to the outer wall 41, the bottom wall 40, and the inner wall 39 of the glass run channel 42 of the partition sash 21. Here, the length of the inner wall 39 of the glass run channel 42 is longer than that of the outer wall 41.

In the inner wall 49 of the glass run 38, a lip 50 fit to the fitting portion 44 of the glass run channel 42 is provided, and in the outer wall 47 of the glass run 38, a lip 51 fit to the another fitting portion 45 of the glass run channel 42 is provided. Additionally, two lips 52 and 52 are provided in the back face of the bottom wall 48 of the glass run 38. The lips 52 and 52 closely contact the bottom wall 40 of the partition sash 21. In the glass run 38 having the structure explained above, a large lip 53 is also formed, which obliquely protrudes from a middle of the inner wall 49, and a small lip 54 is also formed, which obliquely protrudes from the end of the outer wall 47. The large lip 53 and the small lip 54 closely contact a glass holding bracket 55 (indicated by a chain line in FIG. 2) of the rear door glass 16.

According to the present embodiment, the flange portion 32 and the concave portion 31 for realizing a sash structure for holding the partition glass 22 are arranged at a more inner side of the vehicle in comparison with the partition glass 22, thereby realizing a flush surface structure around the partition sash 21. In addition, the apparent width W of the partition sash 21 can be small, thereby improving salability.

Furthermore, the flange portion 32 and the concave portion 31 are also arranged at a more inner side of the vehicle in comparison with the inner wall 27 (of the slot 25 of the glass seal 24) at which the partition glass 22 and the glass seal 24 are adhered; therefore, the height of the flange portion 32 can be determined without influence of the partition glass 22, thereby securing sufficient strength in fitting between the flange portion 32 and the concave portion 31 of the glass seal 24 (to which the flange portion is fit). As a result, a sufficient strength for holding the partition glass 22 can be secured, and it is possible to reliably fit the partition glass 22 via the glass seal 24 and to improve reliability in mounting of the partition glass 22.

As explained above, the partition sash 21 has a cross-sectional form which can be realized by integral molding and thus can be formed by roll molding, extrusion molding, or the like, so that the surface condition of the partition sash 21 can be stable, thereby keeping a preferable state of the glass seal 24 fit to the flange portion 32. Accordingly, it is possible to reduce a burden on the glass seal 24.

In addition, the metal fitting 33 is provided (i.e., embedded) in a portion around the concave portion 31, so that rigidity of the concave portion 31 of the glass seal 24 can be improved, thereby improving rigidity in fitting between the concave portion 31 and the flange portion 32 and improving reliability in fitting in the glass seal 24.

Furthermore, the flange portion 32 which rises toward the back side is turned back to the front side, which increases the thickness of the flange portion 32 and produces a step in the end portion 56, thereby preventing a fall of the concave portion 31 fit to the flange portion 32 while increasing the rigidity of the flange portion 32. In addition, the (pointed) head of the flange portion 32 is formed round, so that it is easy to mount the glass seal 24 to the partition sash 21.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A structure of a door sash of a vehicle, comprising:
a sash portion for holding a door glass;
a glass seal provided at an end portion of the door glass;
outer faces of the door sash, the door glass, and the glass seal being substantially flush; and
a fitting convex portion provided in the door sash more inwardly of the vehicle in comparison with the outer face of the door sash, and fitted to a fitting concave portion provided in the glass seal more inwardly of the vehicle in comparison with the outer face of the glass seal.

2. A structure as claimed in claim 1, wherein the fitting convex portion and the fitting concave portion are formed more inwardly of the vehicle in comparison with a contact portion between the door glass and the glass seal.

3. A structure as claimed in claim 1, wherein the door sash has an integrally molded sectional form.

4. A structure as claimed in claim 1, further comprising a metal fitting embedded in a portion of the glass seal around the fitting concave portion.

5. A structure as claimed in claim 1, wherein in the door sash, the fitting convex portion is a folded portion turning back to an opposite side.

6. A structure as claimed in claim 1, wherein the door sash is a partition sash and the door glass is fixed in position.

7. A structure as claimed in claim 1, wherein the door sash has another portion on an opposite side from said sash portion operatively cooperating with a glass holding bracket of another door glass.

8. A door glass holding structure of a vehicle, comprising:
a door sash including a fitting convex portion; and
a glass seal provided between the door sash and an end portion of a door glass, the glass seal including a fitting concave portion in which said fitting convex portion of said door sash is fitted;
outer faces of the door sash, the door glass, and the glass seal being substantially flush;
the door sash fitting convex portion being disposed more inwardly of the vehicle in comparison with the outer face of the door sash; and
the fitting concave portion being disposed more inwardly of the vehicle in comparison with the outer face of the glass seal.

9. A structure as claimed in claim 8, wherein the fitting convex portion and the fitting concave portion are disposed more inwardly of the vehicle in comparison with a contact portion between the door glass and the glass seal.

10. A structure as claimed in claim 8, wherein the door sash has an integrally molded sectional form.

11. A structure as claimed in claim 8, further comprising a metal fitting embedded in a portion of the glass seal around the fitting concave portion.

12. A structure as claimed in claim 11, wherein said metal fitting is elastic and urges walls of said fitting concave portion toward each other.

13. A structure as claimed in claim 8, wherein in the door sash, the fitting convex portion is a folded portion turning back to an opposite side.

14. A structure as claimed in claim 8, wherein the door sash is a partition sash and the door glass is fixed in position.

15. A structure as claimed in claim 8, wherein the door sash has another portion on an opposite side from said door glass, and operatively cooperating with a glass holding bracket of another door glass.
